(19) United States
(12) Patent Application Publication
(10) Pub. No.: US 2009/0047377 A1
(43) Pub. Date: Feb. 19, 2009

(54) Fish Attractant

(75) Inventor: Benjamin Keith Diggles, Banksia Beach (AU)

Correspondence Address: THE WEBB LAW FIRM, P.C., 700 KOPPERS BUILDING, 436 SEVENTH AVENUE, PITTSBURGH, PA, 15219, US

(73) Assignee: Dunphy Sports/Fishing Imports Pty Ltd, Taren Point (AU)

(21) Appl. No.: 12/191,598

(22) Filed: Aug. 14, 2008

(30) Foreign Application Priority Data
Aug. 16, 2007 (AU) 2007904410

(51) Int. Cl. A01K 97/04; A23K 1/18

(52) U.S. Cl. 426/1

(57) ABSTRACT

Disclosed herein is a fish attractant formulation for application to an object. The formulation comprises a carrier which comprises one or more fatty acids; and a further component that is a fish attractant carried by the carrier. The formulation is adapted to be retained on the object. Also disclosed are a fishing lure or bait coated with the fish attractant formulation, and a method for producing a fish attractant formulation.

### FIELD OF THE INVENTION

The present invention relates to fish attractant formulations, methods for producing fish attractant formulations and objects such as fishing lures and baits coated with fish attractant formulations.

### BACKGROUND TO THE INVENTION

Line fishing involves a combination of angling techniques and fishing equipment to induce fish to bite on a natural or artificial bait. A wide variety of devices, baits, and accessories are used to stimulate fish feeding and/or aggressive attack responses.

One area of particular interest to fishers is that of chemical fish attractants and the formulations for delivering them to fish. Fish attractants must be delivered into the water to be effective, but most attractants are quickly removed from a lure or bait when applied as a surface coating, particularly when ambient and water temperatures are high.

Despite the existence of various chemical fish attractants, reductions in fish stocks and the increasing popularity of recreational fishing around the world has lead to a need to deliver improved attractant formulations that are effective on a variety of fish species, with attractant delivery systems that remain easy for an angler to use with a variety of lures and baits under all angling conditions, including in regions of the world with high ambient and water temperatures.

### SUMMARY OF THE INVENTION

In a first aspect, the present invention provides a fish attractant formulation for application to an object. The formulation comprises a carrier which comprises one or more fatty acids and a further component that is a fish attractant carried by the carrier. The formulation is adapted to be retained on the object.

Typically, the object is a fishing lure or bait (artificial or natural). However, in some embodiments, the object may be a fish food, medicine or growth supplement (e.g. pellets or capsules containing the medicine or growth supplement).

The inventor has found that carriers containing one or more fatty acids can not only provide a carrier having the physical characteristics that enable it to carry the fish attractant and be retained on an object (e.g. a fishing lure) for a sufficient length of time for various fish related applications, but that fatty acids can surprisingly work synergistically with the fish attractant to provide fish with a more complete “sensory experience” when the fish approaches and takes the object. Without wishing to be bound by theory, the inventor believes that because fish require fatty acids in their diet, and since fatty acids comprise a significant proportion of the proximate composition of their natural prey items, the fatty acids can be recognised by the fish using olfaction and gustation and the carrier itself may be a mild attractant.

In some embodiments, the carrier comprises one or more of the following substances having fatty acids: fatty acids, triglycerides, hydrogenated fatty acids and hydrogenated triglycerides. The carrier may consist essentially of one or more of the following substances having fatty acids: fatty acids, triglycerides, hydrogenated fatty acids and hydrogenated triglycerides.

The carrier may, for example, comprise a plant oil and/or substances derived from a plant oil. In some embodiments, the plant oil is a vegetable oil and the carrier comprises a vegetable oil and/or substances derived from a vegetable oil. As used herein, the phrases “vegetable oil” and “plant oil” are to be understood to encompass fats and oils derived from vegetables and fats and oils derived from plants, respectively.

As will be appreciated, plant oils are cheaply and readily available, and are a renewable resource. Plant oils are also biodegradable and can be processed such that they can remain coated on objects such as fishing lures for some time, even when ambient and water temperatures are high. For example, it is possible to hydrogenate plant oils such that their viscosity and melting point can advantageously be adjusted to provide a carrier with the most appropriate physical properties for a particular lure and/or particular target fish.

The carrier may comprise one or more of the following plant oils, and/or substances derived from the following plant oils: castor oil, rapeseed oil, sunflower oil, safflour oil, olive oil, almond oil, peanut oil, hazelnut oil, canola oil, corn oil, palm oil, palm kernel oil, cottonseed oil, linseed oil, sesame oil, rice bran oil, and soybean oil.

In some embodiments, the carrier may comprise castor oil and substances derived from castor oil. For example, the carrier may be a mixture of castor oil, hydrogenated and partially hydrogenated castor oil. Such carriers have been found by the inventor to have both excellent coating properties when applied to a fishing lure, remaining on the lure for a significant number of casts, as well as providing a marked improvement in the catch rates of fish when compared to formulations using identical fish attractants but in which other products (e.g. petrolatum-based products) are used as carriers.

The component that is a fish attractant is typically substantially soluble in water so that it dissolves once the object is placed in the water so it can be sensed by a fish.

The fish attractant formulation may further comprise a water soluble dispersing agent carried by the carrier. The fish attractant formulation may also further comprise preservatives, odourants and/or colouring agents.

In a second aspect, the present invention provides a fishing lure or bait coated with the fish attractant formulation of the first aspect.

In a third aspect, the present invention provides a method for producing a fish attractant formulation. The method comprises the steps of:

adding a fish attractant to a carrier comprising one or more fatty acids to form a mixture; and

blending the mixture (optionally with heating) to produce the fish attractant formulation.

The method may further comprise the step of mixing a water soluble dispersing agent with the fish attractant before adding the fish attractant to the carrier.

In some embodiments, the fish attractant formulation produced using the method of the third aspect is the fish attractant formulation of the first aspect.

In a fourth aspect, the present invention provides a method for enhancing the attractiveness of an object to a fish, the method comprising the step of coating the object with the fish attractant formulation of the first aspect.

### DETAILED DESCRIPTION OF PREFERRED EMBODIMENTS OF THE INVENTION

The fish attractant formulation of the present invention includes a carrier which comprises one or more fatty acids.

Trials conducted by the inventor have shown that formulations of the present invention can result in a significantly increased catch rate when compared with other attractant formulations (e.g. those based on petrolatum carriers) containing identical fish attractants, Without wishing to be bound by theory, the inventor believes that because a mixture of fatty acids are essential to the diet of a fish, and since fatty acids comprise a significant proportion of the proximate composition of their natural prey items, it appears that the fatty acid carrier itself is a mild attractant and works synergistically with the fish attractant carried therein to provide fish with a more complete “sensory experience” when they approach and ingest the object.

The attractant formulation is adapted to be retained on an object (e.g. a fishing lure or bait). Typically, it is the properties of the carrier which cause the resultant formulation to be retained on the object. Thus, carriers typically have a viscosity and consistency whereby they readily adhere to the object and are not easily removed (e.g. when being cast and/or trolled through the water). It will be appreciated that whilst the fish attractant formulation will remain on the object for an appropriate length of time, it is not intended that it will be retained forever on the object, but will eventually be removed at a controlled rate (e.g. after repeated casting and trolling of a fishing lure initially coated with the formulation).

Typically, the carrier comprises or consists essentially of one or more of the following substances: fatty acids, triglycerides, hydrogenated fatty acids and hydrogenated triglycerides. As will be appreciated, all of these substances are either fatty acids or substances whose molecular structure includes fatty acids.

As those skilled in that art will appreciate, the main constituent of plant oils and vegetable oils are triglycerides, which are glycerides esterified with three fatty acids. Using plant oils or substances derived from plant oils as a carrier in a fish attractant provides a number of advantages. For example, the levels of environmental degradation associated with human use of aquatic and marine environments worldwide are increasing and there is therefore an increasing recognition of the need to develop attractant delivery formulations which are biodegradable. Also, depletion of non-renewable resources is a significant problem in the modern world, hence development of attractant delivery formulations based on renewable resources is also desirable.

Thus, in preferred embodiments, the carrier comprises a plant oil (e.g. a vegetable oil), either on its own if its physical properties are appropriate, or in combination with substances derived from the same or another plant/vegetable oil. Alternatively, in other embodiments, the carrier may comprise only substances derived from a plant/vegetable oil.

The physical properties of plant oils can readily be adjusted to provide them with properties whereby they can remain coated on objects such as fishing lures for some time, even when ambient and water temperatures are high. In this respect, plant oils can be hydrogenated (i.e. reacted with hydrogen in the presence of a catalyst) to increase their level of saturation, which causes their viscosity and melting point to increase. Thus, a substance derived from a plant oil (e.g. a hydrogenated or partially hydrogenated triglyceride or a fatty acid or hydrogenated or partially hydrogenated fatty acid) can readily be prepared that provides a carrier with the most appropriate physical properties for a particular lure and/or particular target fish.

A plant oil can also include plant oils derived from plants which have been genetically modified, for example plants genetically modified so they synthesize specific omega 3 long chain fatty acids.

The carrier may comprise any plant or vegetable oil. However, it is expected that one or more of the following plant oils, and/or substances derived from the following plant oils will be especially useful: castor oil, rapeseed oil, sunflower oil, safflour oil, olive oil, almond oil, peanut oil, hazelnut oil, canola oil, corn oil, palm oil, palm kernel oil, cottonseed oil, linseed oil, sesame oil, rice bran oil, and soybean oil.

Other plant oils which may be of use include sunflower seed oil, meadowform seed oil, jojoba oil, corn oil, coconut oil, macadamia oil, babassu oil, squalame oil, safflower oil, apricot kernel oil, mink oil, avocado oil, rice bean oil, wheat germ oil, grape seed oil, borage oil, and evening primrose oil.

In some embodiments, the carrier comprises castor oil and substances derived from castor oil. For example, the carrier may be a mixture of castor oil, hydrogenated and partially hydrogenated castor oil. Such a carrier is sold by Vertellus Specialties Inc. under the trade name Castorlatum®. Fish attractant formulations comprising Castorlatum® have been found by the inventor to have both excellent coating properties when applied to a fishing lure, remaining on the lure for a significant number of casts, as well as providing a marked improvement in the catch rates of fish when compared to formulations in which other products (e.g. petrolatum-based products) are used as carriers.

Unlike previously described fish attractant formulations based on petrolatum carriers, the formulations of the present invention do not require the use of additional thickening agents as the fatty acid mixtures suitable for use as a carrier are highly polar, which means they are thicker, more heat stable, and are able to maintain fluidity at both extremely high and low temperatures. They also have higher lubricity and hence adhere better to the external surfaces of objects such as artificial lures than do guar gum, cellulose, starch alginate or petrolatum based products.

Also, as vegetable oils possess mild anti-microbial and anti-bacterial properties, mixing the fatty acid mixture with the other ingredients forms a chemically compatible emulsion with excellent shelf stability, yet it still releases the active ingredient (the fish attractant) when immersed in water, Vegetable oil derived fatty acid mixtures are recognised as non-toxic, non hazardous and biodegradable, whereas petroleum-based products may contain polycyclic aromatic hydrocarbons (PA/D and other sensitizing substances that take a very long time to biodegrade and can thus be harmful to the environment.

Quantities of the carrier used in the formulation can be varied depending on the desired consistency of the formulation and/or the desired degree of adherence of the formulation, but are usually within the range of 10-95% and most preferably 60 to 80% by weight.

Fish attractant formulations according to the invention also include a further component that is a fish attractant. It is envisaged that any fish attractant can be used in the formulation of the present invention. However, it is preferable that the fish attractant be soluble in water so that it dissolves when the object (e.g. the fishing lure or bait) is in the water, which makes the attractant easier to detect by the fish.

The fish attractant may be any material or combination of materials which attracts or stimulates aquatic life (fish, crustaceans etc.) to feed. A wide variety of water soluble and insoluble attractants, including those described in U.S. Pat. Nos. 4,245,420, 4,826,691, 5,089,277 and 6,827,930 have been found to be suitable.

The percentage of attractant in the attractant formulation of the present invention can be determined primarily by the nature of the specific attractant material and the identity of the target fish species, but broadly, formulations of the present invention containing amounts of fish attractant in the range of between about 0.01-70% of the total formulation by weight, and preferably 10-30% have been found to be effective.

The fish attractant formulation may also include a water soluble dispersing agent. The function of the water soluble dispersing agent is to initially dissolve the fish attractant for incorporation into the carrier, and then to disperse the attractant (by virtue of being water soluble) in a controlled manner when the coated object is in the water.

By varying the amount of the water soluble dispersing agent present in the attractant formulation, the rate of release of the fish attractant into the water can be controlled. For example, in embodiments in which the fish attractant carried in the attractant formulation is soluble in water, upon immersion of the coated object in water (e.g. after the coated fishing lure has been cast into the ocean), the fish attractant will begin to dissolve. In this manner, a “trail” of the attractant is left behind as the lure is trolled back to the user. In some situations, it may be desirable to allow the attractant to dissolve rapidly in order to leave a large “trail” behind the lure. However, in other situations, it may be desirable to cause the attractant to dissolve slowly in order to conserve the attractant so reapplication of the attractant formulation is required less frequently. The amount of water soluble dispersing agent in the attractant formulation thus can be adjusted as desired to control the rate of release of the attractant.

Preferably, the water soluble dispersing agent is non-toxic and biodegradable, for the reasons discussed above. Particularly preferred dispersing agents include propylene glycol and glycerine, but other types of water soluble liquids may be similarly effective as dispersing agents.

Quantities of the dispersion agents used in the formulation can vary depending on the desired consistency of the formulation and/or the desired rate of attractant dispersion, but are usually within the range of 1-50% and most preferably 10 to 30% by weight.

If desired, auxiliary agents can be used in the formulation in amounts between 0 and 20%. These may include salts, water, and/or colours, odourants, preservatives or other components which are used to simplify the process of mixing the ingredients and/or improve its appearance, osmolality, shelf life and/or simplify handling and packaging of the product.

Typically, the object to which the fish attractant formulation will be applied is a fishing lure or bait. However, as those skilled in the art will appreciate, a method by which the attractiveness of an object to a fish can be enhanced has far broader application than just the recreational fishing market.

For example, in the aquaculture industry, large stocks of fish are held in pens in the ocean. It is periodically necessary to give the fish medicines or growth supplements. However, the “taste” of such medicines or growth supplements often causes fish to reject them. It is envisaged that objects (e.g. pellets or capsules) containing or consisting of a medicine or growth supplement could be coated with the fish attractant of the present invention, which would enhance the attractiveness of the object to the fish, resulting in a higher uptake of the medicine or growth supplement.

In preferred embodiments of the present invention, the fish attractant formulation comprises: a fatty acid mixture (derived from vegetable/plant oils and hydrogenated vegetable/plant oils), which is mixed together with a water soluble dispersing agent and any type of fish attractant (preferably water soluble varieties due to their increased effectiveness for attracting fish). This formulation adheres very well to the exterior surface of artificial lures, even at high ambient and water temperatures, while still allowing the active ingredient (the fish attractant) to be released into the water. The formulation described here is easily applied to the surface of a lure, is well accepted by fish, and adheres better at higher temperatures than previously described delivery systems based on gums, carrageenan gums, polysaccharides, starches, cellulose derivatives, and petroleum based products. Furthermore, because the fatty acid mixture can be derived from vegetable oils or plant oils, it biodegrades quickly and comes from a renewable energy resource.

Preferred formulations for the present invention comprise about 60-80% fatty acid mixture, 10-20% water soluble dispersing agent, 10-30% fish attractant and 0-20% auxiliary agents by weight. Particularly preferred formulations include: 60-65% fatty acid mixture, 15-20% water soluble dispersing agent and 20-25% fish attractant and other auxiliary ingredients by weight.

The various ingredients of the formulation can be blended in any manner that produces an emulsion. An emulsion may be preferred due to its uniform appearance, which presents better to the consumer. A uniform emulsion can also result in uniform dispersion of the attractant, which is a desirable benefit. The water soluble dispersing agent, attractant and auxiliary agents may be mixed at room temperature or heated up to 50° C. during mixing with moderate to high shear to help facilitate removal of all lumps and dissolve all components of the attractant so they can then be easily mixed into the fatty acid mixture to form a smooth, creamy, stable emulsion. Typically, the water soluble dispersing agent is mixed with the fish attractant before adding the fish attractant to the carrier. Generally, the components are mixed by hand or with a mechanical mixer until the mixture resembles a smooth, creamy paste that can be readily applied to the exterior of an object such as a bait or artificial lure.

Stability of the final formulation can be measured by a number of different tests. Techniques that have proven to be a reliable indicators of stability for this type of product include examining the performance of a formulation that has withstood heating to a temperature of about 70° C., subjecting the formulation to extended storage in a freezer at temperatures below 0° C., and field testing of the formulation on lures to examine its retention on the lure and ability to attract fish.

In use, the object (e.g. a fishing lure) is coated with the formulation by any suitable method depending on the viscosity of the final formulation and the packaging/dispensing containers available. Suitable packaging/dispensing containers include “toothpaste-type” squeeze bottles with container walls sufficiently flexible to be squeezed and force the formulation through a resealable nozzle, high pressure aerosol cans, or wide mouth jars of plastic or glass of sufficient dimensions that allow a lure to be directly dipped into the formulation while attached to the end of a fishing line.

### Example

A fish attractant formulation according to the invention having the reagents and concentrations identified in Table 1 was prepared and compared with other attractant formulations derived from guar gums, carrageenan gums, polysaccharides, starches, cellulose derivatives, and petroleum based products (e.g. as in U.S. Pat. No. 5,827,551). The fish attractant formulations were mixed in a wide mouth jar that allowed fishing lures to be dipped into the jar and thereby coated with the relevant formulation. In these experiments the same active ingredient (10% by weight water soluble powdered fish attractant mixture) was used in all of the formulations. The solvent used for guar gums, carrageenan gums, polysaccharides, starches, and the cellulose derivatives was water,

TABLE 1
Formulation used in trials

| Ingredient | % by weight |
|---|---|
| Fatty acid mixture | 58% |
| (Castorlatum ®) | |
| Water soluble dispersion | 20% |
| agent (glycerol) | |
| Fish Attractant | 22% |

The formulation according to the invention was found to stable through a wide range of conditions and adhered to a soft bodied fishing lure for a minimum of 15 minutes of repeated casting at water temperatures of 28° C., which was longer than achieved with petrolatum or all other carrier formulations examined (Table 2).

TABLE 2. Results of field trials evaluating retention of attractant on a dry, soft plastic shad lure using various fish attractant delivery systems at 28° C. water temperature.

TABLE 2
Results of comparison experiments

| | | Number of | |
|---|---|---|---|
| Carrier used in the | | casts before | |
| attractant | Attractant | reapplication | |
| formulation | formulation | needed | Comments |
| Present invention | As per Table 1 | Over 30 casts | Thin film remained on |
| | | | lure after 30 casts and |
| | | | over 15 minutes fishing |
| Petroleum jelly | As per preferred | 10-20 casts, | Not detectable after 20 |
| | formula U.S. Pat. | depending on | casts or 10 minutes |
| | No. 5,827,551 | thickness of | fishing |
| | | coating | |
| Guar Gum | Range of 2-20% | 1-6 casts | High concentrations |
| (WW250F, Swift | guar gum in water | | produced a sticky gel, |
| Co. Mulgrave, Vic.) | | | however poor |
| | | | adherence to lure even |
| | | | at high concentrations |
| Carrageenan | Range of 2-20% | 2-5 casts | Produced watery gels, |
| (Gelcarin XP3407C, | gelcarin in water | | majority lost in first 2 |
| Swift Co Mulgrave, | | | casts, poor adherence to |
| Vic.) | | | lure even at high |
| | | | concentrations |
| Sodium CMC | Range of 2-20% | 1-3 casts | Produced watery gels, |
| (Cellogen HP-4H, | cellogen in water | | majority lost in first |
| Swift Co. Mulgrave, | | | cast, poor adherence to |
| Vic.) | | | lure even at high |
| | | | concentrations |
| Methylcellulose | Range of 2-20% | 1-3 casts | Produced watery gels, |
| (Methocel J75MSN, | methocel in water | | majority lost in first |
| Swift Co. Mulgrave, | | | cast, poor adherence to |
| Vic.) | | | lure even at high |
| | | | concentrations |
| Methylcellulose | Range of 2-20% | 2-4 casts | Watery gel, majority |
| (Methocel K15MS, | methocel in water | | lost on first and second |
| Swift Co. Mulgrave, | | | casts, poor adherence to |
| Vic.) | | | lure even at high |
| | | | concentrations |
| Rice Starch | Range of 2-20% | 1 cast | Watery gel, granular at |
| (GZ-1000, Swift Co. | rice starch in | | high concentrations, all |
| Mulgrave, Vic.) | water | | lost on first cast |
| Sodium alginate | Range of 2-10% | No more than | Low concentrations too |
| (Protanal, Swift Co. | protanal in water | 5 casts | watery, higher |
| Mulgrave, Vic.) | with 10-20% | | concentrations of |
| | gelatine, 5% | | alginate become |
| | sugar | | granular, don't adhere |
| | | | to lure very well |

Laboratory trials using the formulation according to the invention on a variety of hard bodied and soft bodied substrates (soft and hard plastic pellets) showed that it was well accepted by fish, which retained the substrates for long periods (>30 sec) and sometimes swallowed smaller items coated with the more potent attractants.

Further field trials in which tournament fishermen used the formulation on hard and soft bodied lures have shown that the catch rates of various species of fish (snapper, bream, mulloway, bass, barramundi, trout and largemouth bass) were significantly higher using the Formulation described in Table 1 than that achieved using the same lures which were unscented, or scented with other products, including the attractant systems referred to in Table 2. The biodegradable attractant formulation of Table 1 showed exceptional adhesion and performance under these conditions at elevated water temperatures.

If it is desirable to maintain the attractant on the lure for a bit longer, the formulation described in Table 1 may be adjusted so it comprises 60% Castorlatum, 18% glycerol, 22% attractant. Alternatively, the fish attractants for trout, bass and Largemouth bass may be different to that used for other species and a lower amount of fish attractant may be required; such formulations may comprise and 72.5-85% Castorlatum, 10-15% glycerol and 5-12.5% attractant.

The preceding examples are presented solely to facilitate an understanding of one preferred embodiment of the present invention. The details of the example are not intended to serve as a limitation on the scope of the appended claims.

For example, as described above, the principles of the present invention could be used to improve the productivity of aquaculture farms by increasing the uptake of usually unpleasant tasting medicines or growth supplements of fish contained in the farms.

As will be appreciated, at least preferred embodiments of the formulations described herein can be produced from renewable resources, are biodegradable, and can work synergistically with fish attractants such that they are very well accepted by fish. The formulation can also adhere to the exterior surface of objects such as artificial lures and baits better than other delivery systems based on guar gums, carrageenan gums, polysaccharides, starches, cellulose derivatives, and petroleum based products, while still allowing the fish attractant to be released into the water at a controlled rate.

A reference herein to a prior art document is not an admission that the document forms part of the common general knowledge in the art in Australia or in any other country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A fish attractant formulation for application to an object, the formulation comprising:
a carrier which comprises one or more fatty acids; and
a further component that is a fish attractant carried by the carrier;
the formulation being adapted to be retained on the object.

2. The fish attractant formulation of claim 1, wherein the carrier comprises one or more of the following substances: fatty acids, triglycerides, hydrogenated fatty acids and hydrogenated triglycerides.

3. The fish attractant formulation of claim 1, wherein the carrier consists essentially of one or more of the following substances: fatty acids, triglycerides, hydrogenated fatty acids and hydrogenated triglycerides.

4. The fish attractant formulation of claim 1, wherein the carrier comprises a plant oil and/or substances derived from a plant oil.

5. The fish attractant formulation of claim 1, wherein the carrier comprises a vegetable oil and/or substances derived from a vegetable oil.

6. The fish attractant formulation of claim 1, wherein the carrier comprises, and/or comprises substances derived from, one or more of the following plant oils: castor oil, rapeseed oil, sunflower oil, safflour oil, olive oil, almond oil, peanut oil, hazelnut oil, canola oil, corn oil, palm oil, palm kernel oil, cottonseed oil, linseed oil, sesame oil, rice bran oil, and soybean oil.

7. The fish attractant formulation of claim 1, wherein the carrier comprises castor oil and substances derived from castor oil.

8. The fish attractant formulation of claim 1, wherein the carrier is a mixture of castor oil, hydrogenated and partially hydrogenated castor oil.

9. The fish attractant formulation of claim 1, wherein the component that is a fish attractant is substantially soluble in water.

10. The fish attractant formulation of claim 1, which further comprises a water soluble dispersing agent carried by the carrier.

11. The fish attractant formulation of claim 10, wherein the water soluble dispersing agent is selected from one or more of the following: propylene glycol, glycerine and sorbitol.

12. The fish attractant formulation of claim 1, which comprises between about 10 to about 95% by weight of the carrier and between about 0.01 to about 70% of the fish attractant.

13. The fish attractant formulation of claim 10, which comprises between about 10 to about 95% by weight of the carrier, about 1 to about 50% by weight of the water soluble dispersing agent and about 0.01 to about 70% of the fish attractant.

14. The fish attractant formulation of claim 1, which further comprises one or more of the following: preservatives, odourants and colouring agents.

15. The fish attractant formulation of claim 1, wherein the object is a fishing lure, bait, fish feed, medicine or growth supplement.

16. A fishing lure or bait coated with the fish attractant formulation of claim 1.

17. A method for producing a fish attractant formulation, the method comprising the steps of:
adding a fish attractant to a carrier comprising one or more fatty acids to form a mixture; and
blending the mixture to produce the fish attractant formulation.

18. The method of claim 17, which comprises the step of mixing a water soluble dispersing agent with the fish attractant before adding the fish attractant to the carrier.

19. The method of claim 17, wherein the resultant formulation is the fish attractant formulation of claim 1.

20. A method for enhancing the attractiveness of an object to a fish, the method comprising the step of coating the object with the fish attractant formulation of claim 1.
